(19) United States
(12) Patent Application Publication
(10) Pub. No.: US 2016/0265589 A1
(43) Pub. Date: Sep. 15, 2016

(54) SLIDING MEMBER

(71) Applicant: CANON KABUSHIKI KAISHA, Tokyo (JP)

(72) Inventors: Tetsuo Hino, Yamato-shi (JP); Naoyuki Koketsu, Komae-shi (JP); Kenji Takashima, Numazu-shi (JP); Akiko Takei, Fujisawa-shi (JP)

(21) Appl. No.: 15/051,037

(22) Filed: Feb. 23, 2016

(30) Foreign Application Priority Data
Mar. 13, 2015 (JP) 2015-050476

(51) Int. Cl. F16C 33/10; F16C 33/14

(52) U.S. Cl. CPC F16C 33/104; F16C 33/145

(57) ABSTRACT

Provided is a sliding member that exhibits a sufficient friction-reducing effect even at room temperature while having suppressing effects on liquid dripping, liquid leakage, and contamination by scattering like grease, and in particular, can satisfactorily reduce a frictional force even at a static friction stage. The sliding member includes, in at least part of a sliding surface thereof, a porous portion and a gel-like composition in the porous portion, in which: the gel-like composition includes a thixotropic gel containing an organic polymer and a lubricating medium; and the organic polymer is contained at from 1 wt % to 50 wt % with respect to the gel-like composition.

### BACKGROUND OF THE INVENTION

1. Field of the Invention

The present invention relates to a sliding member.

2. Description of the Related Art

A sliding member obtained by impregnating a porous material with a friction-reducing material, such as a lubricating oil, has long been known since olden times, and has been widely used in applications such as an oil-retaining bearing (a bearing obtained by impregnating a porous material, such as a sintered metal or a synthetic resin, with a lubricating oil). Various developments have been performed for such sliding member from the viewpoint of energy savings through a reduction in its friction.

For example, Japanese Patent Application Laid-Open No. 2012-17472 discloses, as a sliding member, an oil-retaining bearing using a special lubricating oil serving as a friction-reducing material. Here, in the sliding member of Japanese Patent Application Laid-Open No. 2012-17472, the following composition having heat-reversible gel-like lubricity is utilized as the special lubricating oil (friction-reducing material). While the composition has suppressing effects on liquid dripping, liquid leakage, and contamination by scattering like grease, the composition serves as a low-viscosity lubricating oil through a stimulus. It should be noted that the term “contamination by scattering” as used herein means that a predetermined material scatters to contaminate the destination of the scattering. At this time, the case where the liquid dripping and the liquid leakage do not occur at the destination of the scattering despite the scattering of the material means that the contamination by scattering is suppressed.

In addition, in Japanese Patent Application Laid-Open No. 2012-17472, a lubricant for a bearing to be used in an oil-retaining bearing is given as an example of the composition to be used as the special lubricating oil (friction-reducing material). The lubricant for a bearing is prepared by blending a mineral oil-based liquid lubricating base oil and/or a synthetic liquid lubricating base oil with a bisamide and/or a monoamide producing a heat-reversible gel that repeats liquefaction by a temperature increase and gelation by a temperature decrease. In addition, the lubricant for a bearing is a composition having the lubricity of a heat-reversible gel that becomes liquid only at from 100° C. to 200° C. while maintaining a gel state at from 0° C. to 80° C.

However, the sol-gel phase transition temperature of the composition described in Japanese Patent Application Laid-Open No. 2012-17472 is at least about 80° C. in order that the composition may be provided with the suppressing effects on the liquid dripping, the liquid leakage, and the contamination by scattering like the grease at room temperature. Accordingly, the composition described in Japanese Patent Application Laid-Open No. 2012-17472 necessarily serves as a gel at room temperature but does not function as a lubricating oil (friction-reducing material). As a result, in the oil-retaining bearing serving as the sliding member using the composition described in Japanese Patent Application Laid-Open No. 2012-17472, a sufficient friction-reducing effect is not obtained at room temperature. In addition, the composition described in Japanese Patent Application Laid-Open No. 2012-17472 may not exhibit a satisfactory friction-reducing effect particularly at a static friction stage where the composition is placed under room temperature and sufficient frictional heat is not generated. In other words, the sliding member including the friction-reducing material serving as a lubricating oil through a stimulus while having the suppressing effects on the liquid dripping, the liquid leakage, and the contamination by scattering like the grease has been susceptible to an additional improvement.

### SUMMARY OF THE INVENTION

The present invention provides a sliding member that exhibits a sufficient friction-reducing effect even at room temperature while having suppressing effects on liquid dripping, liquid leakage, and contamination by scattering like grease, and in particular, can satisfactorily reduce a frictional force even at a static friction stage.

A sliding member according to one embodiment of the present invention includes, in at least part of a sliding surface thereof, a porous portion and a gel-like composition in the porous portion, in which:

the gel-like composition includes a thixotropic gel containing an organic polymer and a lubricating medium; and

the organic polymer is contained at from 1 wt % to 50 wt % with respect to the gel-like composition.

Further features of the present invention will become apparent from the following description of exemplary embodiments with reference to the attached drawings.

### BRIEF DESCRIPTION OF THE DRAWINGS

FIGS. 1A and 1B are each a schematic view for illustrating an example of an operation mechanism.

FIG. 2 is a partially enlarged view of an a portion in FIG. 1A.

### DESCRIPTION OF THE EMBODIMENTS

Preferred embodiments of the present invention will now be described in detail in accordance with the accompanying drawings.

A sliding member of the present invention includes, in at least part of a sliding surface thereof, a porous portion and a gel-like composition in the porous portion. In the present invention, the gel-like composition is a thixotropic gel containing an organic polymer and a lubricating medium. In addition, in the present invention, the organic polymer is contained at from 1 wt % to 50 wt % with respect to the gel-like composition.

An embodiment of the present invention is described below.

(Sliding Member)

In the present invention, the sliding member is not limited to a member that slides by moving in a state of being brought into contact with any other member, and includes a member that relatively slides through the motion of any other member in a state of being brought into contact with the other member.

The shape of the sliding member of the present invention is not particularly limited as long as the shape has a contact surface to be brought into contact with any other member, i.e., a sliding surface. Preferred examples of the shape of the sliding member of the present invention include a sheet shape and a doughnut shape.

Next, members in the sliding member of the present invention are described.

(1) Porous Portion

The porous portion constituting the sliding member of the present invention is provided in at least part of the sliding surface of the sliding member, but the porous portion may be provided over the entirety of the sliding surface. In addition, in the present invention, the external shape itself of the sliding member may be the porous portion as a result of the formation of the sliding member itself from a porous material.

As described above, the porous portion needs only to be provided in at least part of the sliding surface of the sliding member of the present invention, and hence the outside of its surface that is not the sliding surface may be covered with a material that is not porous, such as a metal. In addition, upon production of the sliding member of the present invention, for example, a member obtained by embedding the porous material in a matrix that is not porous to the extent that its surface is exposed, or a product obtained by processing part of the surface of the matrix that is not porous to make the surface porous can be used.

In the present invention, the structure of the porous portion, i.e., a structure specified by the physical properties of the porous portion, such as its porosity, void ratio, skeleton diameter, and fine pore diameter, needs only to be appropriately selected in accordance with characteristics which the sliding member is required to have.

The porous material constituting the porous portion is not particularly limited, and one kind of conventionally known materials can be used alone, or two or more kinds thereof can be used in combination, as appropriate in accordance with desired physical properties as long as each of the materials is such that the gel-like composition to be described later can be incorporated into the pores of the material itself. In addition, optimum ones need only to be appropriately selected for the shape and thickness of the porous material, the kinds (an independent pore and a continuous pore) of the fine pores of the porous material, the sizes of the fine pores, the arrangement of the fine pores, and the like in accordance with the desired physical properties of the sliding member of the present invention and applications where the sliding member is used.

In the present invention, the porous material serving as a constituent material for the porous portion is preferably a material having a continuous pore. The term “continuous pore” as used herein refers to an elongated pore extending from the surface of the porous material toward its inside. The porous material having the continuous pore can introduce a larger amount of the gel-like composition into the pore than a porous material having only an independent pore does. In addition, in the present invention, the pore diameter of the continuous pore is preferably from 1 μm to 50 μm. When the pore diameter of the continuous pore is from 1 μm to 50 μm, the gel-like composition can be introduced into the pore by utilizing a capillary phenomenon.

Examples of the porous material to be used in the present invention include: sintered metals such as sintered copper and sintered aluminum; sintered resins such as a sintered fluororesin; sintered carbon; a sintered composite material obtained by adding particles or fibers of a metal or a ceramic to a parent metal phase and solidifying the resultant through sintering; activated carbon; glass wool; a sponge; felt; a ceramic; graphite; and an open-cell foamed sheet, a porous sheet obtained by stretching a synthetic resin sheet, and a porous sheet produced by an extraction method, a solidification method, or the like.

Examples of the synthetic resin constituting the porous sheet include a polyamide resin such as nylon, a polyester resin, a polyurethane resin, a polystyrene resin, a polypropylene resin, and a polysulfone resin. As a matter of course, for example, a resin foam, such as an epoxy resin foam, a melamine resin foam, a urea resin foam, or a phenol resin foam, or a polypropylene resin porous body may also be utilized as the porous sheet.

The case where the porous material to be used is a resin-based porous material is particularly suitable from the viewpoints of, for example, a transportation cost and productivity because the material is reduced in weight and improved in moldability. It should be noted that the resin-based porous material is not particularly limited as long as the material is chemically stable against the gel-like composition to be described later. In addition, the case where the melting temperature of the porous material to be used, i.e., a melting point Tₘ thereof is higher than the Tₘ of the gel-like composition is suitable because the porous material can be impregnated with the gel-like composition after the composition has been heated to be brought into a liquid state.

(2) Gel-Like Composition

The gel-like composition to be used in the sliding member of the present invention is a gel having thixotropy (thixotropic gel), the gel containing an organic polymer and a lubricating medium. In the present invention, a combination of the organic polymer and the lubricating medium constituting the gel-like composition is not particularly limited as long as the gel-like composition has thixotropy. It should be noted that in the present invention, the organic polymer is a material also referred to as “thixotropic agent component.”

In the present invention, the thixotropic gel is a substance having a property intermediate between a gel property shown in a plastic solid and a sol property shown in a non-Newtonian liquid. Specifically, the gel is a gel having the following property: while the gel becomes liquid (a phase transition from the gel to a sol) through the application of a shearing stress, the sol is increased in viscosity to become solid (a phase transition from the sol to the gel) once the application of the shearing stress stops. The thixotropic gel is also called a gel having thixotropy or a gel expressing thixotropy. The gel-like composition having thixotropy has suppressing effects on liquid dripping, liquid leakage, and contamination by scattering like grease because the composition is in a gel state and solidified under room temperature and in a state in which no shear is applied. In addition, as the sol-gel phase transition becomes more sensitive to the shearing stress, the friction-reducing effect of the composition necessarily tends to improve.

It should be noted that a gel-like composition using an organic material such as an organic polymer as a parent body tends to undergo a sol-gel phase transition faster than a gel-like composition using an inorganic material as a parent body does because flowability in the former gel is higher than that in the latter gel. In addition, the organic material such as the organic polymer is preferably used as the thixotropic agent component because the flowability of the gel-like composition after the sol-gel phase transition improves. As a result, in particular, the following tendency is observed: a reduction in frictional force can be performed in an extremely satisfactory manner even at a static friction stage (stage where the sliding member stands still). That is, a gel-like composition containing the organic material, such as the organic polymer, out of the gel-like compositions is desirable because a reducing effect on a difference between the coefficient of static friction and coefficient of dynamic friction of the sliding member tends to improve.

Examples of the organic polymer to be incorporated into the gel-like composition as the thixotropic agent component include: polyethers such as polyethylene glycol and polyethylene oxide; synthetic celluloses such as methylcellulose, ethylcellulose, hydroxyethylcellulose, and hydroxypropylcellulose; oils and fats such as diglycerin monooleate, diglycerin laurate, decaglycerin oleate, diglycerin monolaurate, and sorbitan laurate; hydrogenated castor oil and derivatives thereof; and copolymerized materials such as a cationic crosslinked copolymer, impact-resistant polystyrene (HIPS, polybutadiene/styrene copolymer), and a hydrogenated block copolymer. It should be noted that one kind of the organic polymers listed above may be used alone, or two or more kinds thereof may be used as a mixture.

Particularly in the case where the organic polymer is used as the thixotropic agent component, the hardness of the gel-like composition (thixotropic gel) when the composition is in a gel state tends to be high because a network in the gel is satisfactorily formed by, for example, the entanglement effect of the molecules of the polymer. In addition, in the case where the organic polymer is used as the thixotropic agent component, the molecules of the polymer the entanglement of which is loosened once when the composition is in a sol state are satisfactorily entangled with each other again by the polymer network. Thus, the speed of the sol-gel phase transition in which the composition alternately changes into the sol state and the gel state becomes faster. As a result, the suppressing effects on the liquid dripping, the liquid leakage, and the contamination by scattering are exhibited in an extremely satisfactory manner like the grease.

In addition, when the organic polymer is contained as, for example, the thixotropic agent component into the gel-like composition, the organic polymer is preferably formed of a copolymer. This is because of the following reason: the organic polymer formed of the copolymer is constituted by appropriately combining a plurality of kinds of monomer units having properties different from each other, and hence the properties of the gel-like composition, such as thixotropy and flowability, can be appropriately controlled by regulating, for example, the combination, ratios, and array of the components of the polymer.

In consideration of desired characteristics which the gel-like composition should have, a lubricating medium suitable for the desired characteristics needs only to be selected as the lubricating medium in the gel-like composition. Examples of the lubricating medium include water and an organic solvent such as an oil. In general, when a water-soluble organic polymer is used, a solvent having strong polarity such as water is used as the lubricating medium. In addition, when a water-insoluble (lipophilic) organic polymer is used, an organic solvent having weak polarity, such as an oil, is used as the lubricating oil. In the present invention, the number of kinds of the solvents to be used as the lubricating media may be one, or may be two or more.

In addition, the viscosity of the solvent to be used as the lubricating medium is not particularly limited as long as a gel-like composition having desired physical properties such as thixotropy is obtained. It should be noted that in the case where the viscosity of the solvent to be used as the lubricating medium is low, the viscosity of the gel-like composition when the composition is liquefied by the sol-gel phase transition tends to reduce. When the viscosity of the liquefied gel-like composition is low as described above, the friction-reducing effect tends to enlarge.

In addition to the organic polymer and the lubricating medium, an additive may be appropriately contained in the gel-like composition constituting the sliding member of the present invention. The term “additive” as used herein refers to a substance except the thixotropic agent component formed of an organic low-molecular weight compound or an inorganic compound, and the solvent in the lubricating medium, and examples thereof include a stabilizer such as an antioxidant, and a surfactant such as an organic phosphorus-based compound.

Examples of the thixotropic agent component formed of an organic low-molecular weight compound include: fatty acid amides (such as stearamide and hydroxystearic acid bisamide); and fatty acid esters (such as castor wax, bees wax, and carnauba wax).

Examples of the thixotropic agent component formed of an inorganic compound include silica powder and kaolin powder.

It should be noted that as described above, a gel-like composition formed only of an organic component has a friction-reducing effect higher than that of a gel-like composition containing an inorganic component, and/or has a friction-reducing effect at the static friction stage higher than that of the latter composition in some cases. This is because the incorporation of the inorganic component into the gel-like composition necessarily causes an increase in its viscosity, and owing to the increase in viscosity, friction cannot be satisfactorily reduced even when the composition is in a liquid state (sol state), or the difference between the coefficients of static friction and dynamic friction enlarges.

Therefore, in the present invention, the incorporation of the inorganic component into the gel-like composition is preferably prevented to the extent possible. Specifically, the inorganic component is contained at preferably less than 3 wt %, more preferably less than 0.3 wt % with respect to the gel-like composition. Limiting the content of the inorganic component as described above causes the friction-reducing effect particularly at the static friction stage to appear in an extremely satisfactory manner. That is, such limitation is preferred because the difference between the coefficient of static friction and the coefficient of dynamic friction reduces. In addition, when the gel-like composition is formed by using powder formed of the inorganic compound (e.g., inorganic powder having a silanol group described in Japanese Patent Application Laid-Open No. H09-87158), a large amount of the inorganic compound is needed for thickening the gel-like composition, and the necessity involves problems in terms of poor handleability, dispersibility, and stability of the composition.

In addition, when the lubricating medium in the gel-like composition is water, the incorporation of the inorganic component into the water is preferably prevented to the extent possible.

In the present invention, a composition ratio between the lubricating medium in the gel-like composition and the thixotropic agent component formed of the organic polymer or the like is not particularly limited as long as the ratio provides a gel-like composition having desired physical properties such as thixotropy. In general, the ratio of the thixotropic agent component in the gel-like composition is preferably as small as possible because the sol-gel phase transition tends to be induced by a smaller shear. On the other hand, when the ratio of the thixotropic agent increases, as a matter of course, the composition is liable to gel. The thixotropic agent component is contained at desirably 0.1 wt % or more to 90 wt % or less, preferably 1 wt % or more to 30 wt % or less with respect to the gel-like composition. When the thixotropic agent component is the organic polymer, the organic polymer is contained at 1 wt % or more to 50 wt % or less with respect to the gel-like composition from the viewpoint of the thixotropy of the gel-like composition. The organic polymer is contained at preferably 1 wt % or more to 30 wt % or less, more preferably 5 wt % or more to 30 wt % or less with respect to the gel-like composition.

In the sliding member of the present invention, the extent of a reduction in friction necessarily varies in accordance with, for example, the arrangement position and introduction amount of the gel-like composition, and the thixotropy of the gel-like composition. Here, those characteristics depend on constituent materials (e.g., the organic polymer and the lubricating medium) for, and the composition of, the gel-like composition, and hence the constituent materials for, and the composition of, the gel-like composition are appropriately selected so that desired characteristics may be exhibited.

(3) Action and Effect of Sliding Member of the Present Invention

The gel-like composition having thixotropy is introduced into the porous portion arranged in at least part of the sliding surface of the sliding member of the present invention. Accordingly, the sliding member has suppressing effects on liquid dripping, liquid leakage, and contamination by scattering like grease in a state in which a stress such as a shear (a shearing force or a shearing stress) is not applied. Therefore, in a state in which no stress is applied, the gel-like composition arranged in the porous portion neither leaks from the porous portion nor scatters therefrom. On the other hand, when a shear is applied (a shearing stress is applied) by the sliding of a sliding object on the sliding member of the present invention, the gel-like composition liquefies. Here, even when part of the liquefied gel-like composition scatters from the porous portion, the shear is not applied (the application of the shearing stress is not performed) to the scattered composition and hence the composition gels. Accordingly, additional contamination at the destination of the scattering does not occur. In other words, even if the gel-like composition constituting the sliding member of the present invention scatters, the spread of contamination after the scattering is suppressed.

Meanwhile, when the sliding object is brought into contact with the sliding surface of the sliding member of the present invention, and the sliding member of the present invention or the sliding object slides, a shear is applied to the gel-like composition to induce its sol-gel phase transition, and hence the gel-like composition changes into a lubricating oil state. Accordingly, satisfactory sliding is obtained even at room temperature. In addition, the sol-gel phase transition is induced together with the shear at the time of the initiation of the sliding, and hence a satisfactory friction-reducing effect is obtained even at a static friction stage. As a result, a difference between the coefficient of dynamic friction and coefficient of static friction of the sliding member reduces. In other words, a large measurement variation in coefficient of friction between a stage where a mechanical load such as the shear is applied and a stage where the mechanical load is continuously applied does not occur. That is, a difference Δμ between the coefficient of dynamic friction and the coefficient of static friction serving as the difference in coefficient of friction between the stage where the mechanical load is applied and the stage where the mechanical load is continuously applied reduces.

As can be seen from the foregoing, the sliding member of the present invention exhibits a sufficient friction-reducing effect even at room temperature while having the suppressing effects on the liquid dripping, the liquid leakage, and the contamination by scattering like the grease. In particular, the sliding member can satisfactorily reduce a frictional force at the static friction stage.

(Method of Producing Sliding Member)

A conventionally known method can be appropriately used as a method of producing a sliding member of the present invention, and its specific production process is not particularly limited. The sliding member is produced through, for example, the following steps (1) to (3), and is preferably produced through at least the steps (1) and (2):

(1) a liquefying step of liquefying a gel-like composition;
(2) an embedding step of embedding the liquefied gel-like composition in a porous portion; and
(3) a molding step of applying a pressure while heating the gel-like composition to uniformize a sliding surface.

The respective steps are described below.

(1) Liquefying Step

Available as a method of liquefying the gel-like composition is, for example, a method involving applying a shear to the gel-like composition, or a method involving heating the gel-like composition to a temperature equal to or more than its melting point. Of those methods, a method involving heating the gel-like composition to a temperature equal to or more than its melting point is a suitable method from the viewpoint of the handling of the composition.

(2) Embedding Step

In the present invention, the gel-like composition is embedded in the porous portion provided in at least part of the sliding surface. Here, when the porous portion is provided in the entirety of the sliding surface, the gel-like composition needs only to be embedded in at least part of the sliding surface, but the gel-like composition is preferably embedded over the entirety of the sliding surface. As the area in which the gel-like composition is embedded enlarges, a friction-reducing effect by the embedding of the gel-like composition, in particular, a friction-reducing effect at a static friction stage enlarges.

In addition, the gel-like composition is preferably embedded in the porous portion so as to have a certain thickness from the viewpoint that the friction-reducing effect on the sliding surface exhibited by the gel-like composition is effectively produced. In the present invention, the thickness of the gel-like composition to be embedded in the porous portion is not particularly limited, but when the porous portion constituting the sliding member is provided only near the sliding surface, the thickness of the gel-like composition is preferably adjusted so that a larger amount of the gel-like composition may be embedded in the porous portion.

Here, when the entirety of the sliding member is constituted of a porous material, the gel-like composition is desirably embedded in the porous material so as to have a certain thickness in at least the sliding surface, but the embedding amount and embedding depth (thickness) of the gel-like composition can be appropriately adjusted in accordance with desired material physical properties.

For example, when the shape of the porous material constituting the sliding member is a sheet shape, the gel-like composition is preferably impregnated at from 0.1% to 100% into a fine pore communicating with the sliding surface in a section from its surface toward an opposite surface. When the gel-like composition is embedded so as to have a thickness corresponding to 0.1% or more of the thickness of the sheet, a frictional force-reducing effect exhibited by the sol-gel phase transition of the gel-like composition satisfactorily appears.

Here, for example, a method involving impregnating the porous portion with the gel-like composition that has liquefied in the previous step (liquefying step) is available as a method of embedding the gel-like composition in the porous portion.

(3) Pressing Step

The gel-like composition is embedded in the porous portion by the embedding step, but a pressing treatment or the like may be performed after the embedding step for the purpose of uniformizing the sliding surface.

A specific approach to the pressing treatment is not particularly limited, but for example, hot pressing by thermocompression bonding can be particularly suitably used because the thickness of the gel-like composition can be easily uniformized. It should be noted that the term “hot pressing” as used herein is not limited to the pressing of the composition in a state in which the composition is heated, and includes an increase in temperature of the composition in a state in which the composition is pressed.

A heating temperature, a pressing pressure, and a time period upon performance of this step (pressing step) are not particularly limited as long as the temperature is equal to or less than the decomposition temperature of the organic polymer constituting the gel-like composition. In other words, the temperature and the like need only to be appropriately selected in accordance with, for example, the organic polymer to be used, and a conductive material and a polymer compound constituting a conductive material of the present invention. For example, the temperature of a heat press is preferably set to from 30° C. to 150° C. In addition, the pressing pressure is preferably set to fall within the range of from 1 kg/cm² to 100 kg/cm², and is more preferably set to fall within the range of from 10 kg/cm² to 50 kg/cm².

The sliding member of the present invention is produced through the above-mentioned steps. It should be noted that the surface state of the resultant sliding member and the state of the embedding of the gel-like composition (thixotropic gel) constituting the sliding member can be easily confirmed by direct observation through measurement with a laser microscope or a scanning electron microscope (SEM).

(Applications of Sliding Member)

The sliding member of the present invention exhibits a sufficient friction-reducing effect even at room temperature while having suppressing effects on liquid dripping, liquid leakage, and contamination by scattering like grease. In particular, the sliding member can satisfactorily reduce a frictional force at a static friction stage. Accordingly, the sliding member of the present invention can be suitably utilized as one member constituting, for example, a sliding-contact product such as a sliding bearing, requiring a reduction in friction from the viewpoints of, for example, energy savings and a noise reduction.

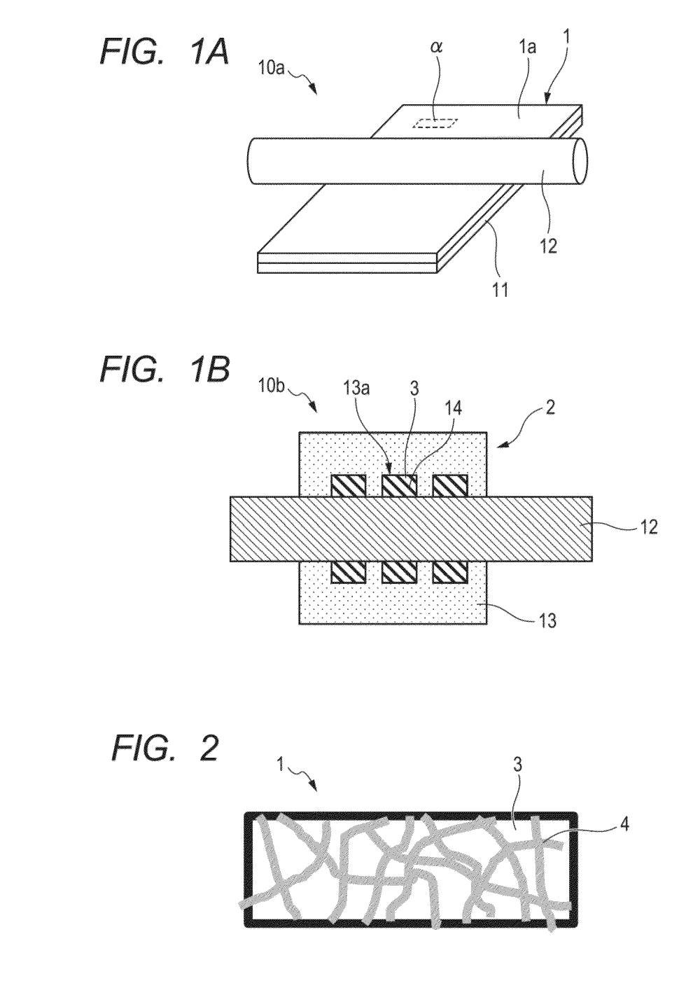

The present invention is explained below with reference to the drawings. FIG. 1A and FIG. 1B are each a schematic view for illustrating an example of an operation mechanism. Specifically, FIG. 1A is a perspective view for illustrating the first example, and FIG. 1B is a sectional view for illustrating the second example. It should be noted that FIG. 1A and FIG. 1B are each also a schematic view for illustrating an example of the use mode of the sliding member of the present invention.

An operation mechanism 10a of FIG. 1A includes a substrate 11 having a flat plate shape, a sheet-like sliding member 1 provided on the substrate 11, and a round bar-like shaft 12 sliding on the surface of the sliding member 1. In the operation mechanism 10a of FIG. 1A, the sliding member 1 is a member including a sheet-like porous material and a gel-like composition (thixotropic gel) in the porous material. FIG. 2 is a partially enlarged view of an a portion in FIG. 1A. In other words, FIG. 2 is a view for illustrating part of the surface of the sliding member 1 in FIG. 1A. In FIG. 2, the sliding member 1 includes a porous material 3 having a plurality of pores having elongated shapes and a gel-like composition 4 filled into the pores of the porous material 3. It should be noted that in the operation mechanism 10a of FIG. 1A, the gel-like composition 4 constituting the sliding member 1 is provided in at least a sliding surface 1a, i.e., the surface of the sliding member 1 to be brought into sliding contact with the shaft 12 (sliding relative to the shaft 12).

Meanwhile, an operation mechanism 10b of FIG. 1B has the round bar-like shaft 12 and a bearing serving as a sliding member 2 sliding relative to the shaft 12. In addition, in FIG. 1B, the bearing serving as the sliding member 2 has three recessed portions 13a provided in part of a bearing main body 13, specifically part of its sliding surface to be brought into sliding contact with the shaft (sliding relative to the shaft 12). Here, each of the recessed portions 13a are provided therein with the porous material 3 having a doughnut shape serving as a porous portion, and the gel-like composition 14 is filled into the porous material 3. It should be noted that the term “doughnut shape” as used herein refers to a cyclic shape along the peripheral direction of a cylinder having a certain width in the direction of the shaft 12, and the inner side surface having the doughnut shape is part of the sliding surface when the sliding member 2 relatively slides in a state of being brought into contact with the shaft 12.

### EXAMPLES

The present invention is described in detail below by way of Examples. However, Examples to be described below are merely illustrative and the present invention is not limited to these Examples. Modifications and alterations of Examples to be described below which are appropriately made within the gist of the invention are also included in the present invention.

(Methods of Evaluating Gel-Like Composition and Sliding Member)

Methods of evaluating gel-like compositions and sliding members obtained in Examples and Comparative Examples to be described later are described below.

(1) Evaluation of Gel-Like Composition for its Suppressing Effects on Liquid Dripping, Liquid Leakage, and Contamination by Scattering

Each of the gel-like compositions (thixotropic gels) prepared in Examples and Comparative Examples to be described later was evaluated for its suppressing effects on liquid dripping, liquid leakage, and contamination by scattering by a method to be described below. First, the gel-like composition was packed into a vial bottle so as to occupy about a half of its volume, and was left at rest under room temperature, and the filling height of the gel (length from the lower surface of the bottle to the surface of the gel) in the state was measured. Next, the vial bottle was slowly inverted and left to stand overnight, and the filling height of the gel (length from the upper surface of the bottle to the surface of the gel) after the standing was measured. Then, the state change ratio of the gel-like composition was calculated from the following calculation formula (1) based on the filling heights of the gel-like composition before and after the standing in the inverted state.

[Filling height of gel after vial bottle has been left to stand in inverted state]/[filling height of gel before inversion of vial bottle]=[state change ratio of gel-like composition] (1)

Then, the result of the calculation was evaluated as any one of the following three stages (i) to (iii) as shown in Table 1 below.

TABLE 1

| State change | | |
|---|---|---|
| ratio of gel-like | | Evaluation |
| composition | State of gel | rank |
| Less than +10% | No change in state of the filling height of | (i) |
| (less than 110%) | the gel is observed after the standing in | |
| | the inverted state as compared to the | |
| | filling height before the standing. | |
| +10% or more to | A slight change in state of the filling | (ii) |
| less than +30% | height of the gel is observed after the | |
| (110% or more to | standing in the inverted state as compared | |
| less than 130%) | to the filling height before the standing. | |
| +30% or more | An extremely large change in state of the | (iii) |
| (130% or more) | filling height of the gel is observed after | |
| | the standing in the inverted state as | |
| | compared to the filling height before the | |
| | standing. | |

Grease was also subjected to the evaluation, and as a result, was evaluated as the rank (i). Accordingly, a gel-like composition evaluated as the rank (i) can be judged to have the same suppressing effects on the liquid dripping, the liquid leakage, and the contamination by scattering as those of the grease. In view of the foregoing, upon evaluation of a gel-like composition for its suppressing effects on the liquid dripping, the liquid leakage, and the contamination by scattering, the composition was evaluated as o (acceptable) when its evaluation rank was the rank (i), and the composition was evaluated as x (unacceptable) when the evaluation rank was anything but the rank (i).

(2) Evaluation of Sol-gel Phase Transition of Gel-like Composition (Thixotropic Gel) at Room Temperature

The sol-gel phase transition of each of the gel-like compositions (thixotropic gels) prepared in Examples and Comparative Examples to be described later at room temperature was confirmed by a method to be described below. That is, a bottle packed with the prepared gel-like composition (thixotropic gel) was vigorously shaken from side to side, and the state change ratio of the gel-like composition was calculated from the following calculation formula (2) by using the filling heights of the gel-like composition before and after the shaking of the bottle.

[Filling height of gel after shaking of bottle]/[filling height of gel before shaking of bottle]=[state change ratio of gel-like composition] (2)

Then, the result of the calculation was evaluated as any one of the following three stages (i) to (iii) as shown in Table 2 below.

TABLE 2

| State change | | |
|---|---|---|
| ratio of gel-like | | Evaluation |
| composition | State of gel | rank |
| Less than +10% | No change in state of the filling | (i) |
| (less than 110%) | height of the gel is observed after the | |
| | shaking of the bottle as compared to | |
| | the filling height before the shaking. | |
| +10% or more to | A slight change in state of the filling | (ii) |
| less than +30% | height of the gel is observed after the | |
| (110% or more to | shaking of the bottle as compared to | |
| less than 130%) | the filling height before the shaking. | |
| +30% or more | An extremely large change in state of | (iii) |
| (130% or more) | the filling height of the gel is | |
| | observed after the shaking of the | |
| | bottle as compared to the filling | |
| | height before the shaking. | |

Here, when a gel-like composition was evaluated as the rank (ii) or (iii), it was recognized that its sol-gel phase transition at room temperature was able to be confirmed, and the composition was evaluated as o (acceptable), and when the composition was evaluated as the rank (i), the composition was evaluated as x (unacceptable).

(3) Friction Evaluation of Sliding Member

The coefficients of friction of each of the samples (sliding members) produced in Examples and Comparative Examples to be described later were measured by a friction test involving using a reciprocating friction tester (manufactured by Shinto Scientific Co., Ltd.). It should be noted that the friction test was performed on the surface of a porous material having embedded therein a gel-like composition. In addition, upon measurement of the coefficients of friction, a set of sliding operations to be performed under the following conditions was performed 30 times.

Material for, and shape of, sliding member:
SUS material, 10-mmφ ball shape

### Load: 100 g

Sliding speed: 600 nm/min
Sliding distance: 30 mm
Number of times of reciprocation: 10 times
Atmosphere: Room temperature, under air

Here, a measured value immediately after the initiation of the test was defined as a coefficient of static friction, and a measured value in the 30th set of sliding operations was defined as a coefficient of dynamic friction. When the coefficient of dynamic friction was 0.2 or less as a result of the measurement, it was recognized that “a sufficient friction-reducing effect was obtained even at room temperature,” and a friction evaluation result was evaluated as o (acceptable). On the other hand, when the coefficient of dynamic friction was more than 0.2, the friction evaluation result was evaluated as x (unacceptable). In addition, a difference Δμ between the coefficient of dynamic friction and the coefficient of static friction was calculated by using the coefficient of dynamic friction and the coefficient of static friction obtained as a result of the measurement, and was evaluated according to the following evaluation criteria.

(a): The Δμ was extremely small (the ratio of the Δμ to the coefficient of dynamic friction was less than 10%).
(b): The Δμ was small (the ratio of the Δμ to the coefficient of dynamic friction was 10% or more to less than 30%).
(c): The Δμ was large (the ratio of the Δμ to the coefficient of dynamic friction was 30% or more).

Here, when the Δμ was small, specifically when the Δμ was evaluated as the rank (a) or (b), it was recognized that “a frictional force was able to be satisfactorily reduced even at a static friction stage,” and the Δμ was evaluated as o (acceptable). On the other hand, when the Δμ was evaluated as the rank (c), the Δμ was evaluated as x (unacceptable).

Here, when all the results of the evaluations (1) to (3) were evaluated as being acceptable (o), it can be said that a sliding member exhibiting a sufficient friction-reducing effect even at room temperature while having suppressing effects on liquid dripping, liquid leakage, and contamination by scattering like grease was obtained.

### Example 1

### (1) Preparation of Gel-Like Composition (Thixotropic Gel)

A gel-like composition (thixotropic gel) was prepared by the following method through the use of HIPS (manufactured by Asahi Kasei Chemicals Corporation), which was a polystyrene-based material, as an organic polymer, and dimethylacetamide (DMAc), which was an amide-based oil, as a lubricating medium.

First, the HIPS and DMAc were mixed. At this time, the content of the HIPS with respect to the entirety of the mixture was adjusted to 5 wt %. Next, the HIPS was dissolved while the mixture was stirred under heating, and then the solution was left at rest under room temperature. Thus, the gel-like composition (thixotropic gel) was obtained.

### (2) Production of Sliding Member

First, the gel-like composition produced in the section (1) was liquefied by being stirred while being heated. Next, a polyethylene resin porous body (manufactured by Nitto Denko Corporation, pore diameter: 17 μm, porosity: 30%, thickness: 2 mm) was impregnated with the liquefied gel-like composition. Next, the surface of the porous body was subjected to hot pressing with a heat press heated to 150° C. under an applied pressure of 0.1 MPa for 1 minute. Thus, a sliding member including the gel-like composition (thixotropic gel) in the porous material was produced.

It should be noted that photographing with a laser microscope confirmed that the thixotropic gel was embedded in the porous material.

### Example 2

A sliding member was produced by the same method as that of Example 1 except that in the section (1) of Example 1, the content of the HIPS with respect to the entirety of the mixture was adjusted to 13 wt %.

### Example 3

A sliding member was produced by the same method as that of Example 1 except that in the section (1) of Example 1, the content of the HIPS with respect to the entirety of the mixture was adjusted to 26 wt %.

### Example 4

A sliding member was produced by the following method with reference to Japanese Patent Application Laid-Open No. 2014-112636 through the use of a mixed material formed of cellulose and a polyether as an organic polymer, and pure water as a lubricating medium.

(1) Preparation of Gel-Like Composition (Thixotropic Gel)

The mixed material and pure water were mixed. At this time, the total content of the mixed material with respect to the entirety of the mixture was adjusted to 12 wt %. Next, the mixed material was dissolved while the mixture was stirred under heating, and then the solution was left at rest under room temperature. Thus, the gel-like composition (thixotropic gel) was obtained.

(2) Production of Sliding Member

The gel-like composition produced in the section (1) was liquefied by being stirred while being heated. Next, a Teflon (trademark) resin porous body (PTFE, manufactured by Nitto Denko Corporation) was impregnated with the liquefied gel-like composition. Next, the surface of the porous body was subjected to hot pressing with a heat press heated to 150° C. under an applied pressure of 0.1 MPa for 1 minute. Thus, a sliding member including the gel-like composition (thixotropic gel) in the porous material was produced.

### Example 5

In the section (1) of Example 1, upon preparation of the gel-like composition, the HIPS, smectite (manufactured by Katakura & Co-op Agri Corporation), and DMAc were mixed. At this time, the contents of the HIPS and smectite with respect to the entirety of the mixture were adjusted to 6 wt % and 1 wt %, respectively. A sliding member was produced by the same method as that of Example 1 except the foregoing.

### Example 6

A sliding member was produced by the following method with reference to Japanese Patent Application Laid-Open No. 2008-533245 through the use of a hydrogenated block copolymer as an organic polymer and an ester oil (soybean oil) as a lubricating medium.

(1) Preparation of Gel-Like Composition (Thixotropic Gel)

The hydrogenated block copolymer and the ester oil (soybean oil) were mixed. At this time, the content of the hydrogenated block copolymer with respect to the entirety of the mixture was adjusted to 22.5 wt %. Next, the hydrogenated block copolymer was dissolved while the mixture was stirred under heating, and then the solution was left at rest under room temperature. Thus, a gel-like composition (thixotropic gel) was obtained.

(2) Production of Sliding Member

The gel-like composition produced in the section (1) was liquefied by being stirred while being heated. Next, a polypropylene resin porous body (manufactured by Fuji Chemical Industries, Ltd., pore diameter: 30 μm, porosity: 35%, thickness: 10 mm) was impregnated with the liquefied gel-like composition. Next, the surface of the porous body was subjected to hot pressing with a heat press heated to 150° C. under an applied pressure of 0.1 MPa for 1 minute. Thus, a sliding member including the gel-like composition (thixotropic gel) in the porous material was produced.

### Comparative Example 1

A sliding member was produced by the same method as that of Example 1 except that in the section (1) of Example 1, the content of the HIPS with respect to the entirety of the mixture was adjusted to 40 wt %.

### Comparative Example 2

### (1) Preparation of Gel-Like Composition (Thixotropic Gel)

Smectite (manufactured by Katakura & Co-op Agri Corporation) and water were mixed. At this time, the content of smectite with respect to the entirety of the mixture was adjusted to 6 wt %. Next, smectite was dissolved while the mixture was stirred under heating, and then the solution was left at rest under room temperature. Thus, a gel-like composition was obtained.

### (2) Production of Sliding Member

The gel-like composition produced in the section (1) was liquefied by being stirred while being heated. Next, a polypropylene resin porous body (manufactured by Fuji Chemical Industries, Ltd., pore diameter: 30 μm, porosity: 35%, thickness: 10 mm) was impregnated with the liquefied gel-like composition. Next, the surface of the porous body was subjected to hot pressing with a heat press heated to 150° C. under an applied pressure of 0.1 MPa for 1 minute. Thus, a sliding member including the gel-like composition in the porous material was produced.

### Comparative Example 3

A sliding member was produced by the following method based on Japanese Patent Application Laid-Open No. 2012-17472.

(1) Preparation of Gel-Like Composition

An amide material (low-molecular weight material) and an ester oil (VG32) were mixed. At this time, the content of the amide material with respect to the entirety of the mixture was adjusted to 17 wt %. Next, the amide material was dissolved while the mixture was stirred under heating, and then the solution was left at rest under room temperature. Thus, a gel-like composition was obtained.

(2) Production of Sliding Member

The gel-like composition produced in the section (1) was liquefied by being stirred while being heated. Next, a polypropylene resin porous body (manufactured by Fuji Chemical Industries, Ltd., pore diameter: 30 μm, porosity: 35%, thickness: 10 mm) was impregnated with the liquefied gel-like composition. Next, the surface of the porous body was subjected to hot pressing with a heat press heated to 150° C. under an applied pressure of 0.1 MPa for 1 minute. Thus, a sliding member including the gel-like composition (thixotropic gel) in the porous material was produced.

(Performance Evaluation)

The results of the evaluations of the respective gel-like compositions and the respective sliding members obtained in Examples and Comparative Examples concerning the “suppressing effects on liquid dripping, liquid leakage, and contamination by scattering,” the “sol-gel phase transition at room temperature,” and the “Δμ” are shown in Table 3 below.

TABLE 3

| | Suppressing effects of | Sol-gel | | |
|---|---|---|---|---|
| | gel-like composition on | phase | | |
| | liquid dripping, liquid | transition at | | Eval- |
| | leakage, and contamination | room | | uation |
| | by scattering | temperature | Δμ | of Δμ |
| Example 1 | ∘ | ∘ (iii) | 0.09 | ∘ (a) |
| Example 2 | ∘ | ∘ (iii) | 0.15 | ∘ (a) |
| Example 3 | ∘ | ∘ (ii) | 0.20 | ∘ (b) |
| Example 4 | ∘ | ∘ (iii) | 0.13 | ∘ (a) |
| Example 5 | ∘ | ∘ (ii) | 0.20 | ∘ (b) |
| Example 6 | ∘ | ∘ (iii) | 0.10 | ∘ (a) |
| Comparative | ∘ | x (i) | — | — |
| Example 1 | | | | |
| Comparative | ∘ | ∘ (ii) | 0.40 | x (c) |
| Example 2 | | | | |
| Comparative | ∘ | x (i) | — | — |
| Example 3 | | | | |

It was found from Examples (Example 1 to Example 6), and Comparative Example 1 and Comparative Example 3 that when a gel-like composition in a sliding member had thixotropy, the sliding member exhibited a sufficient friction-reducing effect even at room temperature while having suppressing effects on liquid dripping, liquid leakage, and contamination by scattering like grease. In addition, it was found that when the gel-like composition in the sliding member had the thixotropy, the sliding member was able to effectively reduce a frictional force particularly in a static friction state. In other words, the sliding member of each of Comparative Example 1 and Comparative Example 3 had the suppressing effects on the liquid dripping, the liquid leakage, and the contamination by scattering, but the thixotropy of its gel-like composition (sol-gel phase transition at room temperature) could not be confirmed. Accordingly, it was shown that the gel-like composition in the sliding member of each of Comparative Example 1 and Comparative Example 3 did not serve as a lubricating component, and hence a reduction in friction at room temperature could not be performed.

In addition, it was found from the results of Example 1 to Example 3 and Comparative Example 1 that even when the same kind of organic polymer was used, a gel-like composition exhibited thixotropy (sol-gel phase transition at room temperature) in some cases, but did not exhibit the thixotropy in other cases in accordance with the content of the polymer in the composition. As can be seen from Comparative Example 1, in a system using the HIPS and DMAc, no thixotropy could be confirmed when the content of the HIPS in the gel-like composition was 40 wt %. In other words, it was shown that the gel-like composition in the sliding member of Comparative Example 1 did not serve as a lubricating component, and hence a reduction in friction at room temperature could not be performed. On the other hand, it was able to be confirmed from Examples 1 to 3 that in the system using the HIPS and DMAc, the content of the HIPS in the gel-like composition was preferably from 1 wt % to 30 wt %.

It was found from the results of Example 1 to Example 6 and Comparative Example 2 that it was essential to incorporate an organic polymer into a gel-like composition. In addition, it was able to be confirmed from the results of Example 5 that even when an inorganic component was incorporated into a gel-like composition, in the case where its content was less than 3 wt % with respect to the gel-like composition, a frictional force was able to be satisfactorily reduced particularly in the static friction state. In other words, in Comparative Example 2, no organic polymer was contained in the gel-like composition and only the inorganic component was contained in the gel-like composition. It was able to be confirmed that in this case, the sliding member had the suppressing effects on the liquid dripping, the liquid leakage, and the contamination by scattering, but did not exhibit a sufficient friction-reducing effect at room temperature, and the evaluation of the Δμ was poor, and hence a reduction in frictional force particularly in the static friction state could not be satisfactorily performed.

As described in Examples above, the sliding member of the present invention was found to exhibit a sufficient friction-reducing effect even at room temperature while having the suppressing effects on the liquid dripping, the liquid leakage, and the contamination by scattering like the grease. In addition, in particular, the sliding member of the present invention was found to be capable of satisfactorily reducing a frictional force even in the static friction state.

The sliding member of the present invention can be utilized as one constituent member for a bearing, electrical and electronic equipment, or the like.

According to the present invention, there can be provided a sliding member that exhibits a sufficient friction-reducing effect even at room temperature while having suppressing effects on liquid dripping, liquid leakage, and contamination by scattering like grease, and in particular, can satisfactorily reduce a frictional force even at a static friction stage.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-050476, filed Mar. 13, 2015, which is hereby incorporated by reference herein in its entirety.

What is claimed is:

1. A sliding member comprising, in at least part of a sliding surface thereof:
a porous portion; and
a gel-like composition in the porous portion, wherein:
the gel-like composition comprises a thixotropic gel containing an organic polymer and a lubricating medium; and
the organic polymer is contained at from 1 wt % to 50 wt % with respect to the gel-like composition.

2. The sliding member according to claim 1, wherein the sliding member has one of a sheet shape and a doughnut shape.

3. The sliding member according to claim 1, wherein the porous portion has a continuous pore.

4. The sliding member according to claim 3, wherein the continuous pore has a pore diameter of from 1 μm to 50 μm.

5. The sliding member according to claim 1, wherein the organic polymer is contained at 1 wt % or more to 30 wt % or less with respect to the gel-like composition.

6. The sliding member according to claim 1, wherein an inorganic component is contained at less than 3 wt % with respect to the gel-like composition.

7. The sliding member according to claim 1, wherein an inorganic component is contained at less than 0.3 wt % with respect to the gel-like composition.

8. The sliding member according to claim 1, wherein the gel-like composition is free of an inorganic component.

9. A bearing comprising a sliding member comprising, in at least part of a sliding surface thereof:
a porous portion; and
a gel-like composition in the porous portion, wherein:
the gel-like composition comprises a thixotropic gel containing an organic polymer and a lubricating medium; and
the organic polymer is contained at from 1 wt % to 50 wt % with respect to the gel-like composition,
wherein the bearing has, in at least part of a sliding surface thereof to be brought into sliding contact with a shaft, a porous portion in the sliding member and a gel-like composition in the porous portion.

10. An operation mechanism comprising:
a shaft; and
a bearing to be brought into sliding contact with the shaft,
wherein the bearing includes a sliding member comprising, in at least part of a sliding surface thereof:
a porous portion; and
a gel-like composition in the porous portion, wherein:
the gel-like composition comprises a thixotropic gel containing an organic polymer and a lubricating medium; and
the organic polymer is contained at from 1 wt % to 50 wt % with respect to the gel-like composition.

11. A method of producing the sliding member of claim 1, comprising:
a liquefying step of liquefying a gel-like composition; and
an embedding step of embedding the liquefied gel-like composition in a porous portion.

12. The method of producing the sliding member according to claim 11, wherein the liquefying step comprises liquefying the gel-like composition by heating the gel-like composition at a temperature higher than a melting point of the gel-like composition.

13. The method of producing the sliding member according to claim 11, further comprising, after the embedding step, a molding step of applying a pressure, while heating the gel-like composition to uniformize a sliding surface.
